(19) United States
(12) Patent Application Publication
(10) Pub. No.: US 2007/0190945 A1
(43) Pub. Date: Aug. 16, 2007

(54) Apparatus and method for receiving a signal in a communication system

(75) Inventors: Joo-Hyun Lee, Suwon-si (KR); Ki-Young Han, Yongin-si (KR); Soon-Young Yoon, Seoul (KR); Keun-Chul Hwang, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/649,102

(22) Filed: Jan. 3, 2007

(30) Foreign Application Priority Data
Jan. 2, 2006 (KR) 286/2006

(51) Int. Cl. H04B 1/00

(52) U.S. Cl. 455/63.1

(57) ABSTRACT

An apparatus and method for receiving a signal in a communication system are provided. Information related to a first modulation scheme applied to a frequency domain in a serving base station is received from the serving base station. Information related to a second modulation scheme applied to the frequency domain in at least one neighbor base station is received from the at least one neighbor base station. A signal is received in the frequency domain. Channel state information is generated by estimating the received signal. A determination is made as to whether to use interference cancellation using the channel state information, the first modulation scheme information and the second modulation scheme information.

### PRIORITY

This application claims the benefit under 35 U.S.C. § 119(a) of a Korean Patent Application filed in the Korean Intellectual Property Office on Jan. 2, 2006 and assigned Serial No. 2006-286, the entire disclosure of which is hereby incorporated by reference.

### BACKGROUND OF THE INVENTION

1. Field of the Invention

The present invention generally relates to an apparatus and method for receiving a signal in a communication system, and more particularly to an apparatus and method for receiving a signal by selecting whether to use interference cancellation according to a modulation scheme in a communication system.

2. Description of the Related Art

Inter-cell interference (ICI) may occur since limited resources, for example, frequency, code and timeslot resources, need to be divided and used in multiple cells of a communication system with a cellular structure (hereinafter, referred to as a cellular communication system).

When frequency resources are divided and used in multiple cells of the cellular communication system, ICI degrades system performance. The frequency resources are reused to increase the overall capacity of the cellular communication system. The rate at which the same frequency resources can be reused is referred to as a “frequency reuse factor”. The frequency reuse factor is defined by the number of cells in which the same frequency resources are unused. Assuming that the frequency reuse factor is K, the number of cells in which the same frequency resources are unused becomes K.

When the frequency reuse factor is small, that is, when the frequency reuse factor is less than 1, the ICI decreases and the amount of frequency resources available in one cell also decreases. Thus the overall capacity of the cellular communication system also decreases. In contrast, when the frequency reuse factor is 1, that is, all the cells constructing the cellular communication system use the same frequency resources, the ICI increases and the amount of frequency resources available in one cell increases. Thus the overall capacity of the cellular communication system also increases.

Extensive research is being conducted on next generation communication systems for providing users with services based on various classes of quality of service (QoS) at a high transmission rate. Wireless local area network (LAN) and metropolitan area network (MAN) communication systems support high-speed services. The wireless MAN communication system is a broadband wireless access (BWA) communication system, and supports a wider service area and a higher transmission rate than the wireless LAN communication system. Thus the next generation communication systems are developing into a form in which the wireless LAN and MAN communication systems can offer mobility and QoS at higher transmission rate.

Among communication systems for applying an orthogonal frequency division multiplexing (OFDM) scheme and an orthogonal frequency division multiple access (OFDMA) scheme to a physical channel of the wireless MAN system in order to support a broadband transmission network, a typical communication system is based on the Institute of Electrical and Electronics Engineers (IEEE) 802.16e standard. An IEEE 802.16e based communication system is a cellular communication system.

FIG. 1 illustrates a structure of the conventional IEEE 802.16e communication system.

Referring to FIG. 1, the IEEE 802.16e communication system has a multi-cell structure, that is, a cell 100 and a cell 150, and is provided with a base station (BS) 110 covering the cell 100, a BS 140 covering the cell 150, and multiple mobile station (MSs) 111, 113, 130, 151 and 153. Signal transmission and reception between the BSs 110 and 140 and the MSs 111, 113, 130 and 150 are performed in the OFDM/OFDMA scheme.

The IEEE 802.16e communication system as illustrated in FIG. 1 has a frequency reuse factor of 1. When the frequency reuse factor is 1 as described above, the amount of frequency resources available in one cell increases and also the efficiency of frequency resources increases. However, since frequency resources, i.e., sub-carriers, are the same between a serving BS and a neighbor BS in a cell overlap area, ICI may occur. Due to the ICI occurrence, the performance of signal reception from the serving BS is degraded at an MS in the cell overlap area.

To compensate for the degradation of the signal reception performance of the MS in the cell overlap area, the IEEE 802.16e communication system applies a robust modulation and coding scheme (MCS) level available therein, modulates and codes MAP information, and transmits the modulated and coded MAP information. Herein, all the BSs of the IEEE 802.16e communication system use the same robust MCS level. The MAP information includes control information such as position information regarding downlink and uplink burst regions, modulation scheme information, and allocation information of the downlink and uplink regions, that is, information regarding whether the downlink and uplink burst regions are dedicatedly allocated to a specific MS or are commonly allocated to unspecific MSs. For example, the IEEE 802.16e communication system modulates and codes the MAP information at a quadrature phase shift keying (QPSK) 12 level and then transmits the information after a maximum of six repeats.

The reception performance of the MAP information at the MS in the cell overlap area may not be improved to a level desired in the IEEE 802.16e communication system even when the MAP information is transmitted at the most robust MCS level available in the IEEE 802.16e communication system. Thus the IEEE 802.16e communication systems use special interference cancellation schemes such as successive interference cancellation (SIC) and the like, to eliminate the ICI.

The performance of the SIC scheme depends on the signal to interference and noise ratio (SINR). For example, when the SINR is low, that is, the size of an interference signal is large (compared to a desired signal), the performance of the SIC scheme is superior. In contrast, as the SINR is high, that is, the size of the interference signal is small, the performance of the SIC scheme is inferior. Thus a scheme for selecting whether to use the SIC scheme according to an SINR (hereinafter referred to as a Norm SIC scheme) has been proposed to eliminate the performance degradation in an SINR range of the SIC scheme.

The Norm SIC scheme uses a ratio between channel power of a serving BS and channel power of a neighbor BS as a measure of the SINR. When a measured SINR is less than a threshold SINR, that is, an interference signal can be correctly measured, a control operation is performed such that the SIC scheme is used. In contrast, when the measured SINR is greater than or equal to the threshold SINR, that is, the interference signal cannot be correctly measured, another control operation is performed so that the Norm SIC scheme is unused. However, the Norm SIC scheme can ensure sub-optimal performance only when the same modulation scheme as that of the neighbor BS is used, that is, the same modulation scheme is applied to a desired signal and an interference signal, as in the case where all the BSs of the IEEE 802.16e communication system transmit MAP information. The neighbor BS transmits the interference signal in the frequency domain, that is, a sub-channel, overlapping the frequency domain in which the desired signal is transmitted. The sub-channel includes at least one sub-carrier.

On the other hand, when the IEEE 802.16e communication system conventionally transmits traffic data, modulation schemes applied to the desired signal and the interference signal are different from each other in many cases. The above-described Norm SIC scheme may ensure optimal performance when same modulation schemes are applied to the desired signal and the interference signal. However, when different modulation schemes are applied to the interference signal and the desired signal as in data traffic, the performance may not be ensured.

### SUMMARY OF THE INVENTION

Another aspect of the present invention is to address at least the above problems and/or disadvantages and to provide at least the advantages described below. Accordingly, an aspect of the present invention is to provide an apparatus and method for receiving a signal in a communication system.

Another aspect of the present invention is to provide an apparatus and method for receiving a signal by selecting whether to use interference cancellation according to a modulation scheme in a communication system.

A further aspect of the present invention is to provide an apparatus and method for receiving a signal by selecting whether to use interference cancellation according to a modulation scheme for each of the signal detection schemes available in a communication system.

In accordance with the present invention, there are provided an apparatus and method for receiving a signal in a communication system, in which information related to a first modulation scheme applied to a frequency domain in a serving base station is received from the serving base station, information related to a second modulation scheme applied to the frequency domain in at least one neighbor base station is received from the at least one neighbor base station, a signal is received in the frequency domain, channel state information is generated by estimating the received signal, and a determination is made whether to use interference cancellation is performed using the channel state information, the first modulation scheme information and the second modulation scheme information.

### BRIEF DESCRIPTION OF THE DRAWINGS

The above and other features and advantages of the present invention will be more apparent from the following detailed description taken in conjunction with the accompanying drawings, in which:

FIG. 1 illustrates a structure of a conventional IEEE 802.16e communication system;

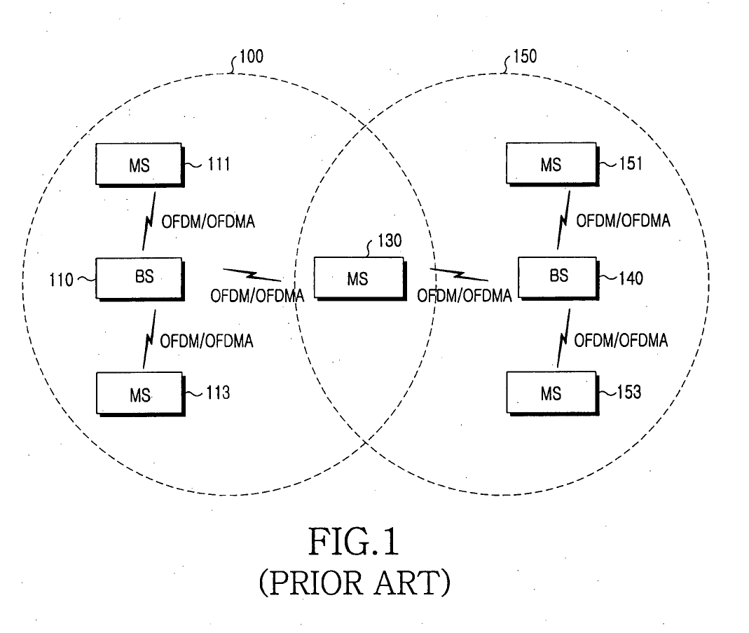

FIG. 2 is a block diagram illustrating an internal structure of a signal receiver in an IEEE 802.16e communication system in accordance with the present invention;

FIG. 3 is a flowchart illustrating an operation process of the signal receiver in which a signal detection scheme uses maximum ratio combining (MRC);

FIG. 4 is a flowchart illustrating an operation process of the signal receiver in which the signal detection scheme uses minimum mean square error (MMSE);

FIG. 5 is a graph illustrating the performance of the signal receiver in which the signal detection scheme uses MRC; and

FIG. 6 is a graph illustrating the performance of the signal receiver in which the signal detection scheme uses MMSE.

### DETAILED DESCRIPTION OF PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention proposes an apparatus and method for receiving a signal by selecting whether to use interference cancellation according to a modulation scheme in a communication system. The present invention proposes an apparatus and method for receiving a signal by selecting whether to use interference cancellation according to a modulation scheme for each of the signal detection schemes available in a communication system. Moreover, the present invention proposes an apparatus and method for receiving a signal by selecting whether to use interference cancellation while considering a modulation scheme when a frequency reuse factor of 1 is used, that is, all base stations (BSs) use the same frequency resources in the communication system. Hereinafter, for convenience of explanation, the Institute of Electrical and Electronics Engineers (IEEE) 802.16e communication system serving as an example of the communication system will be described. Of course, an apparatus and method for eliminating an interference signal in a modulation scheme proposed in the present invention can be applied to other communication systems as well as the IEEE 802.16e communication system.

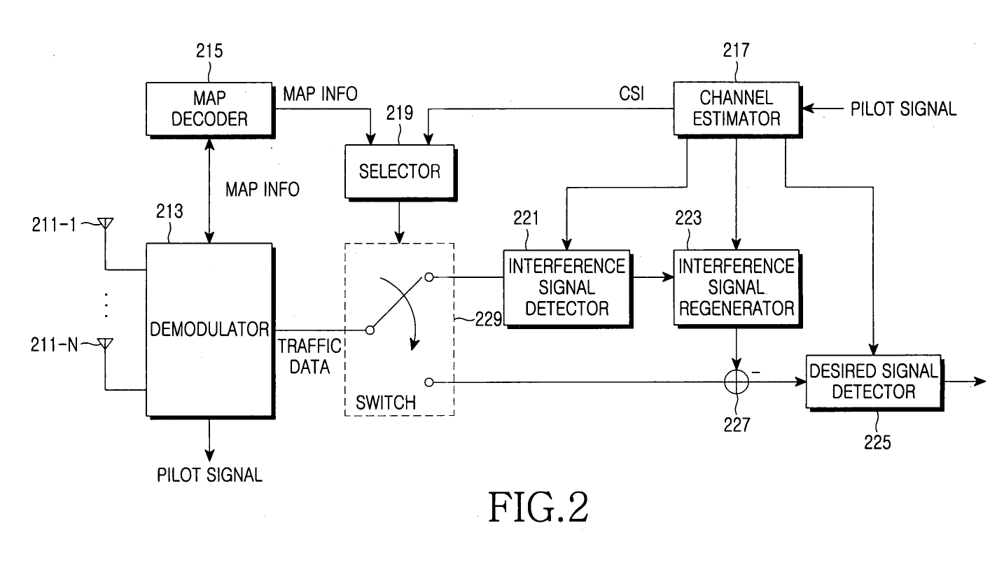

FIG. 2 is a block diagram illustrating an internal structure of a signal receiver in the IEEE 802.16e communication system in accordance with the present invention.

As stated in Description of the Related Art, the IEEE 802.16e communication system is a cellular communication system using the frequency reuse factor of 1. All the BSs of the IEEE 802.16e communication system transmit MAP information in the same modulation scheme. That is, all of the BSs apply the most robust modulation and coding scheme (MCS) level available therein, modulate and code the MAP information, and transmit the modulated and coded MAP information. Since all of the BSs of the IEEE 802.16e communication system use the same robust MCS level, the same modulation scheme is applied to MAP information to be transmitted from all the BSs.

The MAP information includes control information such as position information related to downlink and uplink burst regions, modulation scheme information, and allocation information of the downlink and uplink regions, that is, information related to whether the downlink and uplink burst regions are dedicatedly allocated to a specific mobile station (MS) or are commonly allocated to unspecific MSs. For example, the IEEE 802.16e communication system modulates and codes the MAP information at a quadrature phase shift keying (QPSK) ½ level and then transmits the information after a maximum of six repeats.

As described above, the modulation scheme that is equally applied to the MAP information is the QPSK modulation scheme in the IEEE 802.16e communication system. In the present invention it is assumed that the MS in an overlapping cell area can receive and decode MAP information from both a serving BS and at least one neighbor BS. In FIG. 2, for convenience of explanation, only one neighbor BS is considered. Thus the signal receiver receives signals from the serving BS and the neighbor BS. In the IEEE 802.16e communication system, the MAP information is conventionally transmitted before a data burst and enables the MS to normally receive the data burst.

Referring to FIG. 2, the signal receiver is provided with multiple receive antennas, for example, a total of N receive antennas of a first receive antenna 211-1 to an n-th receive antenna 211-N, a demodulator 213, a MAP decoder 215, a channel estimator 217, a selector 219, an interference signal detector 221, an interference signal regenerator 223, a desired signal detector 225, a subtractor 227 and a switch 229.

When the serving BS and the neighbor BS transmit the MAP information using the same frequency domain, for example, the same sub-channel, the BSs receive the MAP information transmitted on the same sub-channel using the first receive antenna 211-1 to the n-th receive antenna 211-N of the signal receiver. Although signals received through the first receive antenna 211-1 to the n-th receive antenna 211-N are not illustrated in FIG. 2, the received signals undergo a radio frequency (RF) process and a fast Fourier transform (FFT) process and then are output to the demodulator 213.

The demodulator 213 receives an FFT signal, demodulates the received FFT signal in a predefined modulation scheme, and outputs the demodulated signal to the MAP decoder 215. Since the serving BS and the neighbor BS transmit the MAP information at the most robust MCS level, the demodulator 213 demodulates the MAP information transmitted from the serving BS and the MAP information transmitted from the neighbor BS using the same demodulation scheme.

The MAP decoder 215 decodes a signal output from the demodulator 213 using a predefined decoding scheme, recovers the MAP information transmitted from each of the serving BS and the neighbor BS, and outputs the recovered information to the demodulator 213 and the selector 219. The signal receiver can detect information related to a modulation scheme applied to a data burst transmitted from each of the serving BS and the neighbor BS using the same sub-channel and also can detect a position of a pilot signal within the data burst, by recovering the MAP information transmitted from each of the serving BS and the neighbor BS. On the other hand, an example in which the MAP information transmitted from the serving BS and the neighbor BS using the same sub-channel is simultaneously processed, that is, parallel processed, has been described with reference to FIG. 2. Alternatively, the MAP information can be sequentially processed.

When the serving BS transmits a data burst on a specific sub-channel, the signal receiver receives both the data burst transmitted from the serving BS, i.e., the desired signal, and the interference signal transmitted from the neighbor BS using a sub-channel equal to the specific sub-channel. Herein, the desired signal is transmitted from the serving BS using the specific sub-channel, and the interference signal is transmitted from the neighbor BS using the specific sub-channel. That is, the desired signal transmitted from the serving BS and the interference signal transmitted from the neighbor BS are received through the first receive antenna 211-1 to the n-th receive antenna 211-N. The signal receiver receives the desired signal and the interference signal on an associated sub-channel mapped to the MAP information received from the serving BS.

Like the MAP information, the signals received through the first receive antenna 211-1 to the n-th receive antenna 211-N undergo an RF process and an FFT process and then are output to the demodulator 213. The demodulator 213 receives an FFT signal and demodulates the received FFT signal in a predefined demodulation scheme. A pilot signal is output to the channel estimator 217. Traffic data is buffered in a buffer provided in the demodulator 213. Herein, the demodulator 213 demodulates the FFT signal in a demodulation scheme mapped to the MAP information received from the serving BS.

The channel estimator 217 receives the pilot signal output from the demodulator 213, estimates a channel coefficient and noise variance by performing channel estimation, and generates channel state information (CSI) using the estimated channel coefficient and noise variance. The CSI can be generated as channel power information or a signal to interference and noise ratio (SINR), and can be generated as channel power information or an SINR mapped to a signal detection scheme used in the signal receiver. The signal detection scheme can be a maximum ratio combining (MRC) or minimum mean square error (MMSE) scheme. For example, the channel estimator 217 generates the channel power information with the CSI when MRC is used in the signal detection scheme, and generates the SINR with the CSI when MMSE is used in the signal detection scheme. The channel estimator 217 outputs the generated CSI to the selector 219.

The selector 219 selects whether to use interference cancellation in the signal receiver using the MAP information output from the MAP decoder 215, particularly, the modulation scheme information, and the CSI output from the channel estimator 217. An operation for selecting whether to use the interference cancellation in the selector 219 can differ according to signal detection schemes used by the interference signal detector 221 and the desired signal detector 225.

Next the operation for selecting whether to use the interference cancellation in the selector 219 for both the MRC and MMSE schemes serving as the signal detection schemes will be described.

In the operation for selecting whether to use the interference cancellation in the selector 219, a major parameter for conventionally selecting whether to use the interference cancellation in the signal receiver is an error probability when the interference signal is detected from a received signal. That is, if a detection error probability of the interference signal related to the given CSI in the signal receiver is less than that of the desired signal, gain due to the use of the interference cancellation can be obtained when the desired signal is detected after eliminating the detected interference signal from the received signal using the interference cancellation. In contrast, if the detection error probability of the interference signal is greater than or equal to that of the desired signal, incorrect interference signal detection and the degradation of performance due to use of the interference cancellation can be prevented when the interference cancellation is unused. In particular, when interference cancellation using a slicer is applied to a symbol before decoding, a symbol error probability is the major parameter for selecting whether to use the interference cancellation. An optimal condition for selecting whether to use the interference cancellation is given as shown in Equation (1).

$${P}_{s , sym} \begin{matrix}ON \\ \geq \\ < \\ OFF\end{matrix} {P}_{i , sym} \qquad ( 1 )$$

In Equation (1), P_{s,sym} is a symbol error probability of the desired signal, P_{i,sym} is a symbol error probability of the interference signal, ON indicates that use of the interference cancellation is selected if an associated condition is satisfied, and OFF indicates that the use of the interference cancellation is not selected if an associated condition is satisfied. If the symbol error probability of the desired signal is greater than or equal to that of the interference signal as shown in Equation (1), the interference cancellation may be used. On the other hand, if the symbol error probability of the desired signal is less than that of the interference signal, the interference cancellation may not be used.

For example, when the modulation scheme is QPSK, the symbol error probability can be computed as shown in Equation (2) by estimating an SINR per instantaneous symbol in every symbol from the given CSI.

$${P}_{QPSK} = Q ( \sqrt{{γ}_{sym}} ) = Q ( \sqrt{\frac{{\vert {h}_{sym} \vert}^{2} {P}_{sym}}{{σ}^{2}}} ) \qquad ( 2 )$$

In Equation (2), PQ_{PSK} is a symbol error probability when the modulation scheme is QPSK, γ_{sym} is an SINR per instantaneous symbol, Q(•) is a general Q function, |h_{sym}|² is channel power of an associated symbol, P_{sym} is transmit power of an associated symbol, and σ² is noise variance.

However, an operation for computing a symbol error probability per symbol as shown in Equation (2) may lead to an increase in complexity. Thus the present invention proposes a sub-optimal condition for selecting whether to use the interference cancellation approximated using a characteristic of a monotonic decreasing function corresponding to the Q function. In particular, the present invention proposes sub-optimal conditions for selecting whether to use the interference cancellation in each of the MRC and MMSE schemes serving as the signal detection schemes.

When the signal receiver uses multiple receive antennas, for example, two receive antennas, a received signal vector can be expressed as shown in Equation (3).

$$r = [ \begin{matrix}{r}_{1} \\ {r}_{2}\end{matrix} ] = [ \begin{matrix}{h}_{s , 1} & {h}_{i , 1} \\ {h}_{s , 2} & {h}_{i , 2}\end{matrix} ] [ \begin{matrix}{d}_{s} \\ {d}_{i}\end{matrix} ] + [ \begin{matrix}{n}_{s} \\ {n}_{i}\end{matrix} ] = Hd + n \qquad ( 3 )$$

In Equation (3), the subscripts s and i are an index of the desired signal and an index of the interference signal, respectively,

$$H = [ \begin{matrix}{h}_{s , 1} & {h}_{i , 1} \\ {h}_{s , 2} & {h}_{i , 2}\end{matrix} ]$$

is a vector of a channel response matrix among the two receive antennas and the serving and neighbor BSs,

$$d = [ \begin{matrix}{d}_{s} \\ {d}_{i}\end{matrix} ]$$

is a vector representing transmitted symbols of the desired signal and the interference signal, and

$$n = [ \begin{matrix}{n}_{1} \\ {n}_{2}\end{matrix} ]$$

is a vector representing additive white Gaussian noise (AWGN).

First the sub-optimal condition for selecting whether to use the interference cancellation will be described when the MRC scheme is used as the signal detection scheme.

When the MRC scheme is used as the signal detection scheme, the sub-optimal condition for selecting whether to use the interference cancellation as shown in Equation (4) can be generated from the optimal condition for selecting whether to use the interference cancellation as shown in Equation (1).

$${P}_{s , sym} \begin{matrix}ON \\ \geq \\ < \\ OFF\end{matrix} {P}_{i , sym} ⇒ \frac{{γ}_{i}}{{β}_{i} {k}_{i}} ⇒ \begin{matrix}ON \\ \geq \\ < \\ OFF\end{matrix} \frac{{\sum }_{j = 1}^{2} {\vert {h}_{i , j} \vert}^{2}}{{β}_{i} {k}_{i}} \begin{matrix}ON \\ \geq \\ < \\ OFF\end{matrix} \frac{{\sum }_{j = 1}^{2} {\vert {h}_{s , j} \vert}^{2}}{{β}_{s} {k}_{s}} \qquad ( 4 )$$

In Equation (4), the subscripts s and i are an index of the desired signal and an index of the interference signal, respectively, β is a weight based on approximation of a symbol error probability, γ is an SINR per symbol, k is modulation order, j is an index of a receive antenna provided in the signal receiver, ON indicates that use of the interference cancellation is selected if an associated condition is satisfied, and OFF indicates that the use of the interference cancellation is not selected if an associated condition is satisfied. Herein, β has a variable value, and is the weight assigned to select whether to use the interference cancellation while considering the modulation order, that is, the modulation scheme. That is, the use of interference cancellation mapped to the sub-optimal condition for selecting whether to use interference cancellation as shown in the rightmost equation of Equation (4) is selected. For example, β can be set according to modulation schemes as shown in Table 1.

TABLE 1

| | BPSK | QPSK | 16QAM | 64QAM |
|---|---|---|---|---|
| k | 1 | 2 | 4 | 6 |
| β | 1 | 1 | 2.5 | 7 |

As shown in Table 1, β differs according to binary phase shift keying (BPSK), QPSK, 16-quadrature amplitude modulation (16QAM) and 64-quadrature amplitude modulation (64QAM).

Second the sub-optimal condition for selecting whether to use the interference cancellation will be described when the MMSE scheme is used as the signal detection scheme.

When the MMSE scheme is used as the signal detection scheme, an SINR is used as the CSI. A weight matrix based on the MMSE scheme as shown in Equation (5) can be computed from the received signal vector as shown in Equation (3). For convenience of explanation, the weight matrix based on the MMSE scheme is referred to as the MMSE weight matrix.

$$W = [ \begin{matrix}{w}_{s} \\ {w}_{i}\end{matrix} ] = {( {H}^{II} H + {σ}^{2} {I}_{2} )}^{- 1} {H}^{II} = {AH}^{II} \qquad ( 5 )$$

In Equation (5), wₛ=[w_{s,1} w_{s,2}]^{T} and wᵢ=[w_{i,1} w_{i,2}]^{T} are a weight vector of the desired signal and a weight vector of the interference signal, respectively, the superscript H is Hermitian matrix, and A=(H^{//}H+σ²I₂)⁻¹ is an inverse matrix for computing the MMSE weight matrix. Herein, each of the diagonal elements of A=(H^{//}+σ²I₂)⁻¹ indicates mean square error (MSE) for an associated transmitted signal. In wₛ=[w_{s,1} w_{s,2}]^{T} and wᵢ=[w_{i,1} w_{i,2}]^{T}, the superscript T is transpose.

The SINR can be estimated from the MSE as shown in Equation (6).

$$SINR = \frac{E ( {\vert {\sum }_{n = 1}^{2} {h}_{s , n} \vert}^{2} ) {P}_{s}}{E ( {\vert {\sum }_{n = 1}^{2} {h}_{i , n} \vert}^{2} ) {P}_{i} + {σ}^{2}} \approx \frac{1}{MSE} \qquad ( 6 )$$

In Equation (6), Pₛ and Pᵢ are mean symbol power of the desired signal and mean symbol power of the interference signal, respectively. Assuming that P is equal to Pᵢ (Pₛ=Pᵢ), the SINR is approximated to a reciprocal of the MSE. Thus the SINR of the desired signal and the SINR of the interference signal can be expressed as SINRₛ=1/a₁₁, and SINRᵢ=1/a₂₂, respectively. The sub-optimal condition for selecting whether to use the interference cancellation as shown in Equation (7) can be generated from the optimal condition for selecting whether to use the interference cancellation as shown in Equation (1) using these SINRs. a₁₁ is a reciprocal of the approximated SINR of the desired signal when the SINR of the desired signal is approximated to a reciprocal of the MSE of the desired signal, and a₂₂ is a reciprocal of the approximated SINR of the interference signal when the SINR of the interference signal is approximated to a reciprocal of the MSE of the interference signal.

$${P}_{s , sym} \begin{matrix}ON \\ \geq \\ < \\ OFF\end{matrix} {P}_{i , sym} ⇒ \frac{{γ}_{i}}{{β}_{i} {k}_{i}} \begin{matrix}ON \\ \geq \\ < \\ OFF\end{matrix} \frac{{γ}_{s}}{{β}_{s} {k}_{s}} ⇒ {a}_{11} {β}_{s} {k}_{s} \begin{matrix}ON \\ \geq \\ < \\ OFF\end{matrix} {a}_{22} {β}_{i} {k}_{i} \qquad ( 7 )$$

The use of the interference cancellation mapped to the sub-optimal condition for selecting whether to use the interference cancellation as shown in the rightmost equation of Equation (7) is selected.

As described above, the selector 219 can select use or non-use of the interference cancellation.

First the case where the selector 219 selects the use of the interference cancellation will be described.

When selecting the use of the interference cancellation, the selector 219 controls a switching operation of the switch 229 such that traffic data buffered in the buffer of the demodulator 213 is input to the interference signal detector 221 and the subtractor 227. Then the interference signal detector 221 detects an interference signal from the traffic data, and outputs the detected interference signal to the interference signal regenerator 223. A signal detection scheme used by the interference signal detector 221 can be the MRC or MMSE scheme. An operation for detecting the interference signal from the traffic data using the MRC or MMSE scheme is a general operation. Since the interference signal detection operation is not directly related to the present invention, a detailed description is omitted herein.

The interference signal regenerator 223 receives and regenerates the interference signal output from the interference signal detector 221 and then outputs the regenerated interference signal to the subtractor 227. An operation for regenerating the interference signal in the interference signal regenerator 223 is a general operation. Since the regeneration operation is not directly related to the present invention, a detailed description is omitted herein.

The subtractor 227 subtracts the regenerated interference signal output by the interference signal regenerator 223 from the traffic data output by the demodulator 213, and provides the desired signal detector 225 with an output signal of the subtractor 227. The desired signal detector 225 detects a desired signal from the signal output from the subtractor 227. A signal detection scheme used in the desired signal detector 225 can be the MRC or MMSE scheme, and can be the same as that used in the interference signal detector 221. An operation in which the desired signal detector 225 detects the desired signal from the signal output by the subtractor 227 using the MRC or MMSE scheme is a general operation. Since the desired signal detection operation is not directly related to the present invention, a detailed description is omitted herein.

Second the case where the selector 219 selects the non-use of the interference cancellation will be described.

When selecting the non-use of the interference cancellation, the selector 219 controls a switching operation of the switch 229 such that traffic data buffered in the buffer of the demodulator 213 is output only to the subtractor 227. Then the subtractor 227 outputs the traffic data from the demodulator 213 to the desired signal detector 225 without a special subtraction operation. The desired signal detector 225 detects a desired signal from a signal output from the subtractor 227.

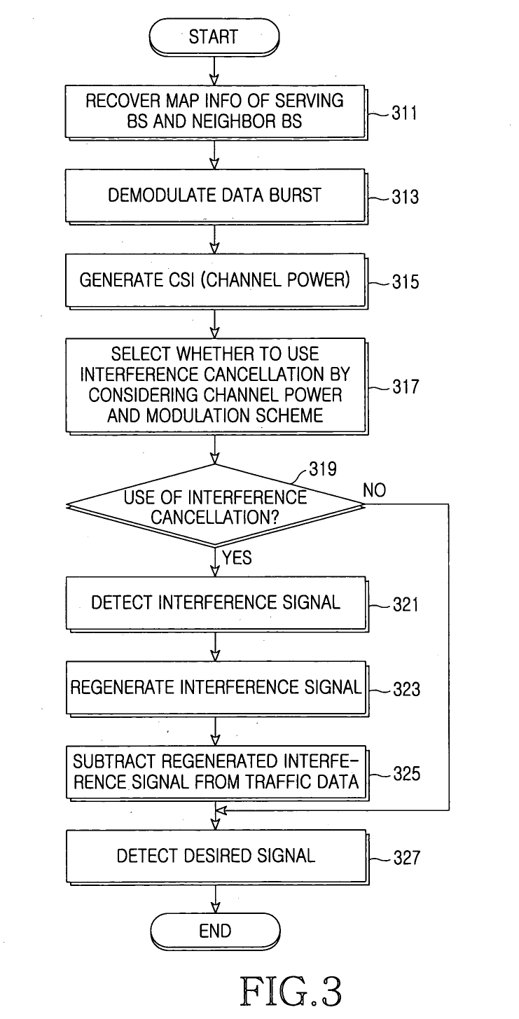

Next an operation process of the signal receiver will be described with reference to FIG. 3 when the MRC scheme is used as the signal detection scheme of the signal receiver, that is, the signal detection scheme used in the interference signal detector 221 and the desired signal detector 225 is the MRC scheme.

FIG. 3 is a flowchart illustrating an operation process of the signal receiver in which the signal detection scheme uses MRC.

Referring to FIG. 3, the signal receiver recovers MAP information of a serving BS and a neighbor BS in step 311. The signal receiver demodulates a data burst mapped to the recovered MAP information in step 313 The data burst is demodulated into traffic data and a pilot signal. The signal receiver generates CSI using the pilot signal in step 315. Since the MRC scheme is used as the signal detection scheme, the signal receiver generates channel power information with the CSI. The signal receiver selects whether to use the interference cancellation while considering the channel power information and a modulation scheme included in the MAP information in step 317. An operation for selecting whether to use the interference cancellation depends on Equation (4). A detailed description of the selection operation is omitted herein.

In step 319, the signal receiver determines whether to use the interference cancellation. If the signal receiver determines to use the interference cancellation, the signal receiver proceeds to step 321. The signal receiver detects an interference signal from the traffic data in step 321. The signal receiver regenerates an interference signal from the detected interference signal in step 323. The signal receiver subtracts the regenerated interference signal from the traffic data in step 325. The signal receiver detects a desired signal from a signal generated by subtracting the regenerated interference signal from the traffic data in step 327 and then ends the operation process.

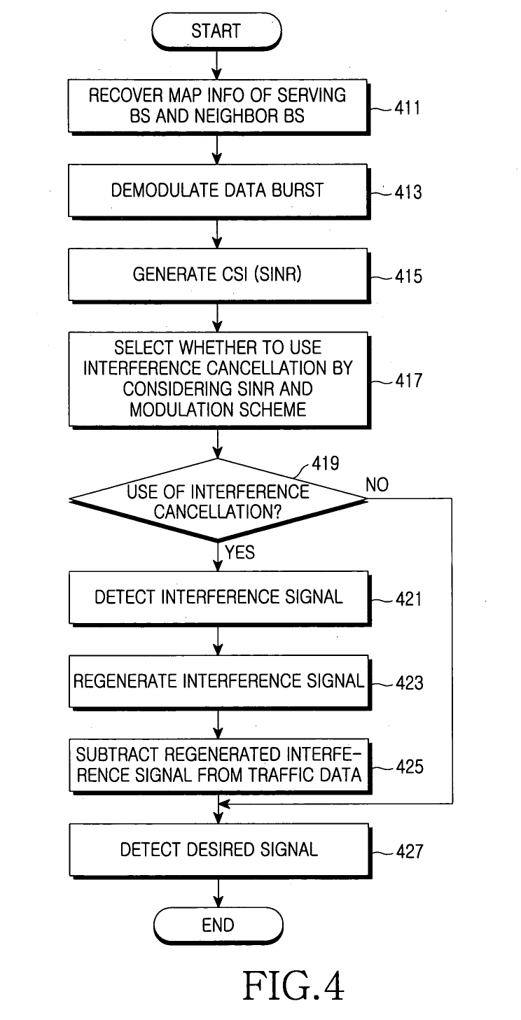

Next an operation process of the signal receiver will be described with reference to FIG. 4 when the MMSE scheme is used as the signal detection scheme of the signal receiver, that is, the signal detection scheme used in the interference signal detector 221 and the desired signal detector 225 is the MMSE scheme.

FIG. 4 is a flowchart illustrating an operation process of the signal receiver in which the signal detection scheme uses MMSE.

Referring to FIG. 4, the signal receiver recovers MAP information of a serving BS and a neighbor BS in step 411. The signal receiver demodulates a data burst mapped to the recovered MAP information in step 413. The data burst is demodulated into traffic data and a pilot signal. The signal receiver generates CSI using the pilot signal in step 415. Since the MMSE scheme is used as the signal detection scheme, the signal receiver generates an SINR with the CSI. The signal receiver selects whether to use the interference cancellation while considering the SINR and a modulation scheme included in the MAP information in step 417. An operation for selecting whether to use the interference cancellation depends on Equation (7).

In step 419, the signal receiver determines whether to use the interference cancellation. If the signal receiver determines to use the interference cancellation, the signal receiver proceeds to step 421. The signal receiver detects an interference signal from the traffic data in step 421. The signal receiver regenerates an interference signal from the detected interference signal in step 423. The signal receiver subtracts the regenerated interference signal from the traffic data in step 425. The signal receiver detects a desired signal from a signal generated by subtracting the regenerated interference signal from the traffic data in step 427 and then ends the operation process.

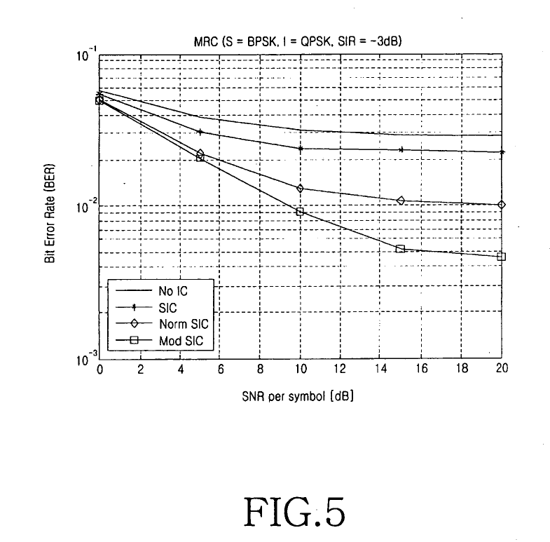

Next the performance of the signal receiver will be described with reference to FIG. 5 when the signal detection scheme uses MRC.

FIG. 5 is a graph illustrating the performance of the signal receiver in which the signal detection scheme uses MRC. In the performance graph as illustrated in FIG. 5, it is assumed that the signal receiver is provided with two transmit antennas, BPSK is applied to a desired signal, QPSK is applied to an interference signal, and a signal to interference ratio (SIR) is −3 dB.

Referring to FIG. 5, it can be seen that the performance is bad when interference cancellation is unused (as indicated by ‘No IC’). When successive interference cancellation (SIC) is used (as indicated by ‘SIC’), it can be seen that gain due to the interference cancellation is obtained but the degradation of performance due to incorrect interference cancellation occurs and therefore a bit error rate (BER) of 1% is not achieved. When a scheme for selecting whether to use the SIC while considering only the SINR (hereinafter, referred to as a Norm SIC scheme) is used (as indicated by ‘Norm SIC’), the BER of 1% can be achieved at an SNR per symbol of about 20 dB since the SIC scheme is used only if a channel state is superior.

On the other hand, it can be seen that interference cancellation in accordance with the present invention, that is, interference cancellation considering a modulation scheme (hereinafter, referred to as a Mod SIC scheme) (as indicated by ‘Mod SIC’), can obtain a higher gain of about 10 dB at the BER of 1% in comparison with the Norm SIC scheme.

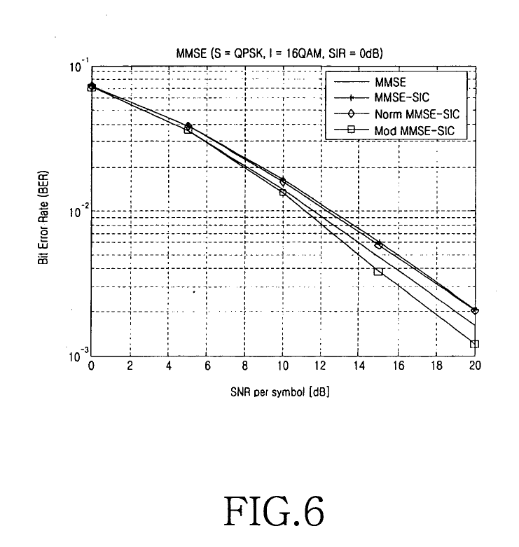

Next the performance of the signal receiver will be described with reference to FIG. 6 when the signal detection scheme uses MMSE.

FIG. 6 is a graph illustrating the performance of the signal receiver in which the signal detection scheme uses MMSE.

In the performance graph as illustrated in FIG. 6, it is assumed that the signal receiver is provided with two transmit antennas, QPSK is applied to a desired signal, 16QAM is applied to an interference signal, and an SIR is 0 dB.

Referring to FIG. 6, a symbol error probability at the SIR of 0 dB is higher than that at the SIR of −3 dB when the interference signal is detected. Thus, the performance at the BER of 1% in the SIC scheme (as indicated by ‘MMSE-SIC’) or the Norm SIC scheme (as indicated by ‘Norm MMSE-SIC’) is 1% less than that in a non-interference-cancellation scheme (as indicated by ‘MMSE’). However, it can be seen that a Mod SIC scheme (as indicated by ‘Mod MMSE-SIC’) in accordance with the present invention can obtain the performance improvement of 1.5 dB or more in comparison with the Norm SIC scheme.

As is apparent from the above description, the present invention can improve signal reception performance by selecting whether to use interference cancellation according to a modulation scheme in a communication system. Moreover, the present invention can improve signal reception performance by selecting whether to use interference cancellation according to a modulation scheme when each of the available signal detection schemes is used in a communication system.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for receiving a signal in a signal receiver, comprising:
receiving, from a serving base station, information related to a first modulation scheme applied to a frequency domain in the serving base station;
receiving, from at least one neighbor base station, information related to a second modulation scheme applied to the frequency domain in the at least one neighbor base station;
receiving a signal in the frequency domain;
generating channel state information by estimating the received signal; and
determining whether to use interference cancellation using the channel state information, the first modulation scheme information and the second modulation scheme information.

2. The method of claim 1, wherein the channel state information includes channel power when a signal detection scheme applied to the received signal is a maximum ratio combining (MRC) scheme.

3. The method of claim 2, wherein determining whether to use the interference cancellation comprises:
determining whether to use the interference cancellation according to a condition defined by
$$\frac{{\sum }_{j = 1}^{2} {\vert {h}_{i , j} \vert}^{2}}{{β}_{i} {k}_{i}} \begin{matrix}\begin{matrix}\begin{matrix}ON \\ \geq \end{matrix} \\ <\end{matrix} \\ OFF\end{matrix} \frac{{\sum }_{j = 1}^{2} {\vert {h}_{s , j} \vert}^{2}}{{β}_{s} {k}_{s}} ,$$
where s is an index of a signal of the frequency domain transmitted from the serving base station, i is an index of a signal of the frequency domain transmitted from the at least one neighbor base station, j is an index of a receive antenna provided in the signal receiver, β is a weight assigned to select whether to use the interference cancellation while considering the modulation scheme, k is modulation order, h is a channel response, ON indicates that use of the interference cancellation is selected if an associated condition is satisfied, and OFF indicates that the use of the interference cancellation is not selected if an associated condition is satisfied.

4. The method of claim 1, wherein the channel state information is a signal to interference and noise ratio (SINR) when a signal detection scheme applied to the received signal is a minimum mean square error (MMSE) scheme.

5. The method of claim 4, wherein determining whether to use the interference cancellation comprises:
determining whether to use the interference cancellation according to a condition defined by:
$${a}_{11} {β}_{s} {k}_{s} \begin{matrix}\begin{matrix}\begin{matrix}ON \\ \geq \end{matrix} \\ <\end{matrix} \\ OFF\end{matrix} {a}_{22} {β}_{i} {k}_{i} ,$$
where s is an index of a desired signal corresponding to a signal of the frequency domain transmitted from the serving base station, i is an index of an interference signal corresponding to a signal of the frequency domain transmitted from the at least one neighbor base station, j is an index of a receive antenna provided in the signal receiver, β is a weight assigned to select whether to use the interference cancellation while considering the modulation scheme, k is modulation order, a₁₁ is a reciprocal of an approximated SINR of the desired signal when the SINR of the desired signal is approximated to a reciprocal of a mean square error (MSE) of the desired signal, a₂₂ is a reciprocal of an approximated SINR of the interference signal when the SINR of the interference signal is approximated to a reciprocal of an MSE of the interference signal, ON indicates that use of the interference cancellation is selected if an associated condition is satisfied, and OFF indicates that the use of the interference cancellation is not selected if an associated condition is satisfied.

6. A method for receiving a signal in a signal receiver, comprising:
receiving, from a serving base station, first MAP information including information related to a first modulation scheme applied to a frequency domain in the serving base station;
receiving, from at least one neighbor base station, second MAP information including information related to a second modulation scheme applied to the frequency domain in the at least one neighbor base station;
receiving a data burst comprising traffic data and a pilot signal in the frequency domain;
generating channel state information by estimating the pilot signal; and
determining whether to use interference cancellation using the channel state information, the first modulation scheme information and the second modulation scheme information.

7. The method of claim 6, wherein the channel state information includes channel power when a signal detection scheme applied to the traffic data is a maximum ratio combining (MRC) scheme.

8. The method of claim 7, wherein determining whether to use the interference cancellation comprises:
determining whether to use the interference cancellation according to a condition defined by
$$\frac{{\sum }_{j = 1}^{2} {\vert {h}_{i , j} \vert}^{2}}{{β}_{i} {k}_{i}} \begin{matrix}\begin{matrix}\begin{matrix}ON \\ \geq \end{matrix} \\ <\end{matrix} \\ OFF\end{matrix} \frac{{\sum }_{j = 1}^{2} {\vert {h}_{s , j} \vert}^{2}}{{β}_{s} {k}_{s}} ,$$
where s is an index of a data burst of the frequency domain transmitted from the serving base station, i is an index of a data burst of the frequency domain transmitted from the at least one neighbor base station, j is an index of a receive antenna provided in the signal receiver, β is a weight assigned to select whether to use the interference cancellation while considering the modulation scheme, k is modulation order, h is a channel response, ON indicates that use of the interference cancellation is selected if an associated condition is satisfied, and OFF indicates that the use of the interference cancellation is not selected if an associated condition is satisfied.

9. The method of claim 6, wherein the channel state information is a signal to interference and noise ratio (SINR) when a signal detection scheme applied to the traffic data is a minimum mean square error (MMSE) scheme.

10. The method of claim 9, wherein determining whether to use the interference cancellation comprises:
determining whether to use the interference cancellation according to a condition defined by
$${a}_{11} {β}_{s} {k}_{s} \begin{matrix}\begin{matrix}\begin{matrix}ON \\ \geq \end{matrix} \\ <\end{matrix} \\ OFF\end{matrix} {a}_{22} {β}_{i} {k}_{i} ,$$
where s is an index of a desired signal corresponding to a data burst of the frequency domain transmitted from the serving base station, i is an index of an interference signal corresponding to a data burst of the frequency domain transmitted from the at least one neighbor base station, j is an index of a receive antenna provided in the signal receiver, β is a weight assigned to select whether to use the interference cancellation while considering the modulation scheme, k is modulation order, a₁₁ is a reciprocal of an approximated SINR of the desired signal when the SINR of the desired signal is approximated to a reciprocal of a mean square error (MSE) of the desired signal, a₂₂ is a reciprocal of an approximated SINR of the interference signal when the SINR of the interference signal is approximated to a reciprocal of an MSE of the interference signal, ON indicates that use of the interference cancellation is selected if an associated condition is satisfied, and OFF indicates that the use of the interference cancellation is not selected if an associated condition is satisfied.

11. An apparatus for receiving a signal in a communication system, comprising:
a demodulator for receiving, from a serving base station, information related to a first modulation scheme applied to a frequency domain in the serving base station, receiving, from at least one neighbor base station, information related to a second modulation scheme applied to the frequency domain in the at least one neighbor base station, and receiving a signal in the frequency domain;
a channel estimator for generating channel state information by estimating the received signal; and
a selector for selecting whether to use interference cancellation using the channel state information, the first modulation scheme information and the second modulation scheme information.

12. The apparatus of claim 11, wherein the channel state information includes channel power when a signal detection scheme applied to the received signal is a maximum ratio combining (MRC) scheme.

13. The apparatus of claim 12, wherein the selector selects whether to use the interference cancellation according to a condition defined by
$$\frac{{\sum }_{j = 1}^{2} {\vert {h}_{i , j} \vert}^{2}}{{β}_{i} {k}_{i}} \begin{matrix}\begin{matrix}\begin{matrix}ON \\ \geq \end{matrix} \\ <\end{matrix} \\ OFF\end{matrix} \frac{{\sum }_{j = 1}^{2} {\vert {h}_{s , j} \vert}^{2}}{{β}_{s} {k}_{s}} ,$$
where s is an index of a signal of the frequency domain transmitted from the serving base station, i is an index of a signal of the frequency domain transmitted from the at least one neighbor base station, j is an index of a receive antenna provided in the apparatus, β is a weight assigned to select whether to use the interference cancellation while considering the modulation scheme, k is modulation order, h is a channel response, ON indicates that use of the interference cancellation is selected if an associated condition is satisfied, and OFF indicates that the use of the interference cancellation is not selected if an associated condition is satisfied.

14. The apparatus of claim 11, wherein the channel state information is a signal to interference and noise ratio (SINR) when a signal detection scheme applied to the received signal is a minimum mean square error (MMSE) scheme.

15. The apparatus of claim 14, wherein the selector selects whether to use the interference cancellation according to a condition defined by
$${a}_{11} {β}_{s} {k}_{s} \begin{matrix}\begin{matrix}\begin{matrix}ON \\ \geq \end{matrix} \\ <\end{matrix} \\ OFF\end{matrix} {a}_{22} {β}_{i} {k}_{i} ,$$
where s is an index of a desired signal corresponding to a signal of the frequency domain transmitted from the serving base station, i is an index of an interference signal corresponding to a signal of the frequency domain transmitted from the at least one neighbor base station, j is an index of a receive antenna provided in the apparatus, β is a weight assigned to select whether to use the interference cancellation while considering the modulation scheme, k is modulation order, a₁₁ is a reciprocal of an approximated SINR of the desired signal when the SINR of the desired signal is approximated to a reciprocal of a mean square error (MSE) of the desired signal, a₂₂ is a reciprocal of an approximated SINR of the interference signal when the SINR of the interference signal is approximated to a reciprocal of an MSE of the interference signal, ON indicates that use of the interference cancellation is selected if an associated condition is satisfied, and OFF indicates that the use of the interference cancellation is not selected if an associated condition is satisfied.

16. An apparatus for receiving a signal in a communication system, comprising:
a demodulator for receiving, from a serving base station, first MAP information that includes information related to a first modulation scheme applied to a frequency domain in the serving base station, receiving, from at least one neighbor base station, second MAP information that includes information related to a second modulation scheme applied to the frequency domain in the at least one neighbor base station, and receiving a data burst comprising traffic data and a pilot signal in the frequency domain;
a channel estimator for generating channel state information by estimating the pilot signal; and
a selector for selecting whether to use interference cancellation using the channel state information, the first modulation scheme information and the second modulation scheme information.

17. The apparatus of claim 16, wherein the channel state information includes channel power when a signal detection scheme applied to the traffic data is a maximum ratio combining (MRC) scheme.

18. The apparatus of claim 17, wherein the selector selects whether to use the interference cancellation according to a condition defined by
$$\frac{{\sum }_{j = 1}^{2} {\vert {h}_{i , j} \vert}^{2}}{{β}_{i} {k}_{i}} \begin{matrix}\begin{matrix}\begin{matrix}ON \\ \geq \end{matrix} \\ <\end{matrix} \\ OFF\end{matrix} \frac{{\sum }_{j = 1}^{2} {\vert {h}_{s , j} \vert}^{2}}{{β}_{s} {k}_{s}} ,$$
where s is an index of a data burst of the frequency domain transmitted from the serving base station, i is an index of a data burst of the frequency domain transmitted from the at least one neighbor base station, j is an index of a receive antenna provided in the apparatus, β is a weight assigned to select whether to use the interference cancellation while considering the modulation scheme, k is modulation order, h is a channel response, ON indicates that use of the interference cancellation is selected if an associated condition is satisfied, and OFF indicates that the use of the interference cancellation is not selected if an associated condition is satisfied.

19. The apparatus of claim 16, wherein the channel state information is a signal to interference and noise ratio (SINR) when a signal detection scheme applied to the traffic data is a minimum mean square error (MMSE) scheme.

20. The apparatus of claim 19, wherein the selector selects whether to use the interference cancellation according to a condition defined by
$${a}_{11} {β}_{s} {k}_{s} \begin{matrix}\begin{matrix}\begin{matrix}ON \\ \geq \end{matrix} \\ <\end{matrix} \\ OFF\end{matrix} {a}_{22} {β}_{i} {k}_{i}$$
where s is an index of a desired signal corresponding to a data burst of the frequency domain transmitted from the serving base station, i is an index of an interference signal corresponding to a data burst of the frequency domain transmitted from the at least one neighbor base station, j is an index of a receive antenna provided in the apparatus, β is a weight assigned to select whether to use the interference cancellation while considering the modulation scheme, k is modulation order, a₁₁ is a reciprocal of an approximated SINR of the desired signal when the SINR of the desired signal is approximated to a reciprocal of a mean square error (MSE) of the desired signal, a₂₂ is a reciprocal of an approximated SINR of the interference signal when the SINR of the interference signal is approximated to a reciprocal of an MSE of the interference signal, ON indicates that use of the interference cancellation is selected if an associated condition is satisfied, and OFF indicates that the use of the interference cancellation is not selected if an associated condition is satisfied.
